(19) United States
(12) Patent Application Publication
(10) Pub. No.: US 2002/0139908 A1
(43) Pub. Date: Oct. 3, 2002

(54) Equipment adjusting leg

(76) Inventors: Junji Oyama, Sagamihara-shi (JP); Yuki Kamada, Sagamihara-shi (JP)

Correspondence Address: NIXON PEABODY, LLP, 8180 GREENSBORO DRIVE, SUITE 800, MCLEAN, VA, 22102, US

(21) Appl. No.: 10/106,330

(22) Filed: Mar. 27, 2002

(30) Foreign Application Priority Data
Mar. 29, 2001 (JP) 2001-095118

(51) Int. Cl. F16M 11/20

(52) U.S. Cl. 248/188.8

(57) ABSTRACT

An equipment adjusting leg is provided concerning which the engagement of a concavo-convex part of a screw of the leg with a locking element is barely loosened when a fine adjustment is made. The adjusting leg comprises: a leg 10 which is provided in the lower part of an external frame of the equipment in a manner capable of moving up and down, and the lower part of which is formed as a ground contact part 16 and the upper part of which is formed as a sliding shaft 17 with a screw-like concavo-convex part 18 provided around its periphery; an element for locking the up-and-down movements of the leg; and an element for releasing the lock; wherein the concavo-convex part 18 of the leg 10 is formed in a trapezoidal shape so that the engagement of the concavo-convex part of the screw of the leg 10 with the locking element is barely loosened when a fine adjustment is made.

### BACKGROUND OF THE INVENTION

1. Field of the Invention

The present invention relates to equipment adjusting legs which are used to adjust the gradient and height of the equipment when electronic and electrical equipment or appliances such as washing machines and projectors are set on the floor or desk.

2. Description of the Related Art

As a conventional method often used for adjusting the height of equipment such as washing machines, there is a method of loosening a nut, turning a bolt to adjust the height, and then tightening the nut. However, this method has a drawback that the height adjusting operations are cumbersome.

Accordingly, as an adjusting leg capable of easily adjusting the height, there exist a device described in Japanese Utility Model (Kokoku) Publication No. SHO 55-28230 and an invention described in Japanese Patent Laid-Open (Kokai) Publication No. HEI 2-66397. This device and utility model includes: a supporting leg provided at the bottom of a piece of equipment in a manner movable up and down; and an adjusting lever (or lock lever) for preventing the movement of the supporting leg by engaging with the peripheral surface of the supporting leg. The supporting leg has a screw-like spiral groove to allow a fine adjustment.

However, with this conventional adjusting leg, concerning the shape of a normal screw thread, the thread is inclined to form an acute edge as in the case of a metric screw thread. Accordingly, when a fine adjustment is made by turning the leg (or screw), the engagement of a concavo-convex part of the screw of the supporting leg with the inside surface (or concavo-convex part) of the adjusting lever (or lock lever) is sometimes loosened, thereby causing the equipment to fall down. Particularly, the smaller the diameter of the screw becomes, the sharper a lead angle becomes and the lesser the depth of engagement between the screws becomes, thereby causing the engagement to be loosened more easily.

### SUMMARY OF THE INVENTION

The present invention is designed to solve the above-described problems. It is an object of this invention to provide an equipment adjusting leg concerning which the engagement of the concavo-convex part of the screw of the supporting leg with a locking element is barely loosened.

This invention adopts the following structure in order to achieve the above-described object.

An equipment adjusting leg according to this invention comprises: a leg provided in a manner capable of moving back and forth relative to an external frame of a piece of equipment and having a sliding shaft for enabling the movement; a locking element for locking the back-and-forth movement of the leg; and a lock release element for releasing the lock; wherein the sliding shaft has a spiral concavo-convex part formed around its periphery, and the concavo-convex part is in a trapezoidal shape.

The leg can be provided in the lower part of the external frame of the equipment in a manner capable of moving up and down, and the lower part of the leg can be formed as a ground contact part and the upper part of the leg can be formed as the sliding shaft.

The sliding shaft can be composed of a screw.

The locking element can comprise: an attaching case for inserting the sliding shaft therethrough; a locking piece pivoted on the attaching case in a rotatable manner and having a concavo-convex part to engage with the concavo-convex part of the sliding shaft; and an engagement maintaining element for maintaining the engagement of the concavo-convex part of the sliding shaft with the concavo-convex part of the locking piece; wherein the concavo-convex part of the sliding shaft can be made of resin.

The resin may be made of engineering plastic. The engineering plastic can be selected from a group consisting of polycarbonate, polyamide, polyacetal, PBT, and combinations of these respective materials and glass fibers.

### BRIEF DESCRIPTION OF THE DRAWINGS

FIG. 1 is an exploded perspective view of an equipment adjusting leg according to Example 1 of the present invention.

FIG. 2 is a front view of the equipment adjusting leg according to Example 1 of this invention in an assembled state.

FIG. 3 is a sectional view of the leg of this invention.

FIG. 4 is a sectional view of the equipment adjusting leg in the assembled state according to Example 1 of this invention when it is locked.

FIG. 5 is a sectional view of the equipment adjusting leg in the assembled state according to Example 1 of this invention when the lock is released.

FIG. 6 is a sectional view of an equipment adjusting leg in the assembled state according to Example 2 of this invention when it is locked.

FIG. 7 is a sectional view of the equipment adjusting leg in the assembled state according to Example 2 of this invention when the lock is released.

### DETAILED DESCRIPTION OF THE PREFERRED EMBODIMENTS

### EXAMPLE 1

An embodiment of the equipment adjusting leg according to this invention (hereinafter referred to as “Example 1”) is hereinafter described with reference to the attached drawings.

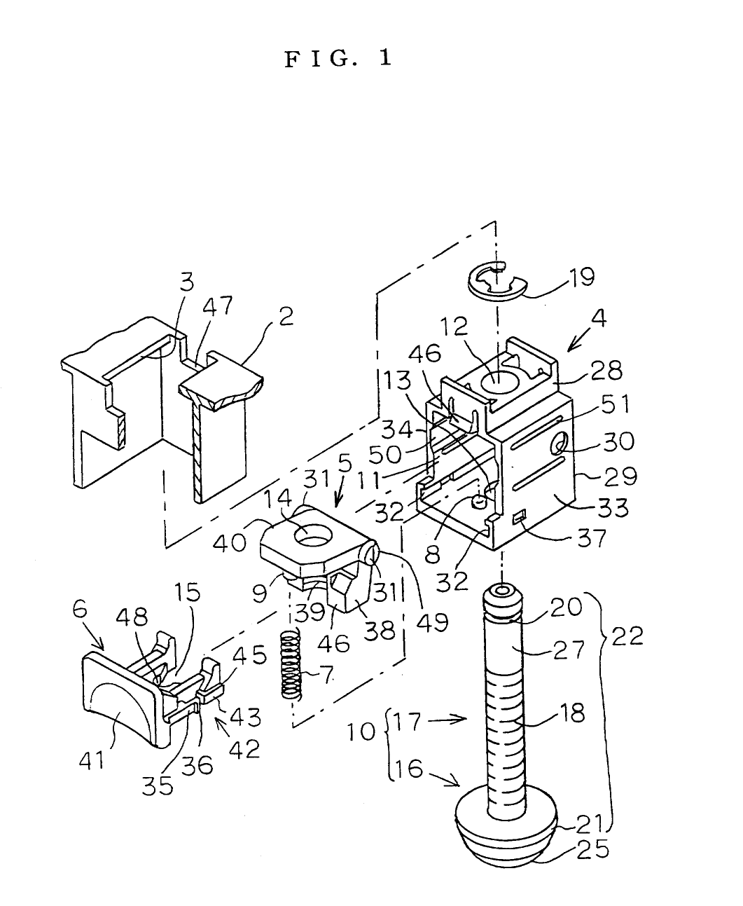

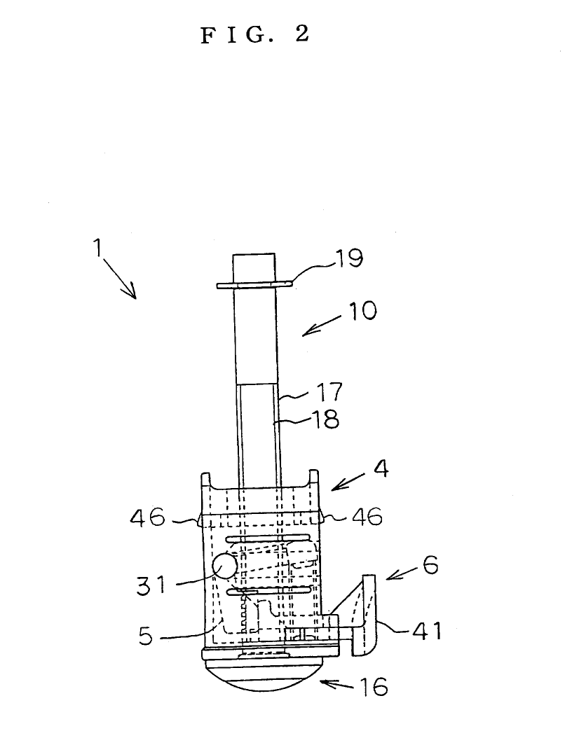

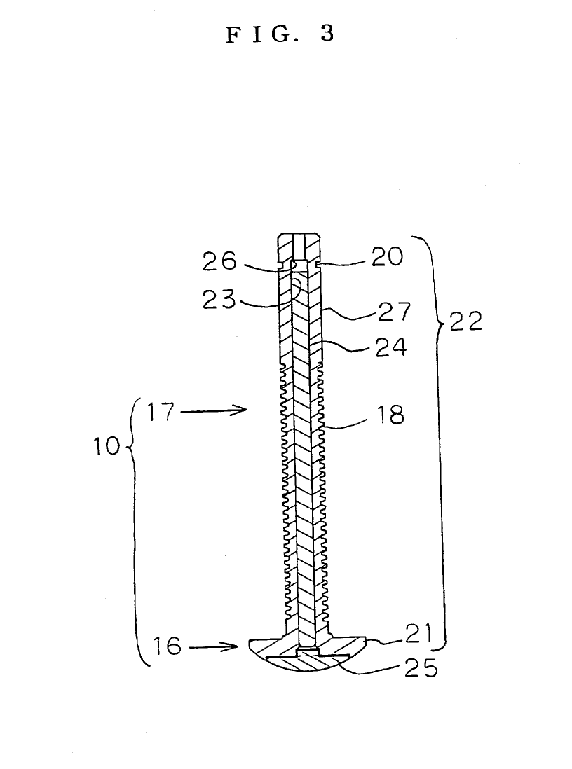

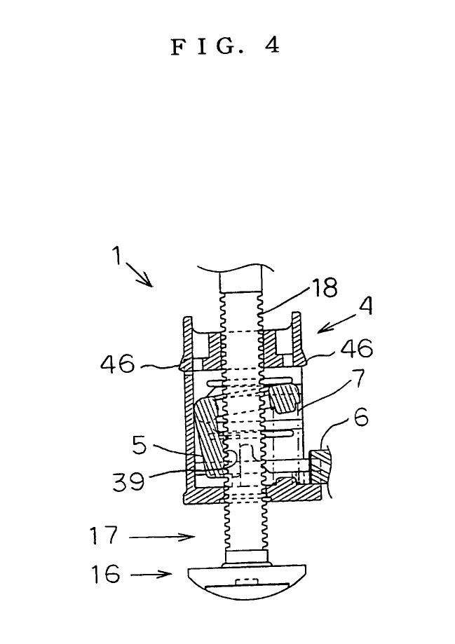

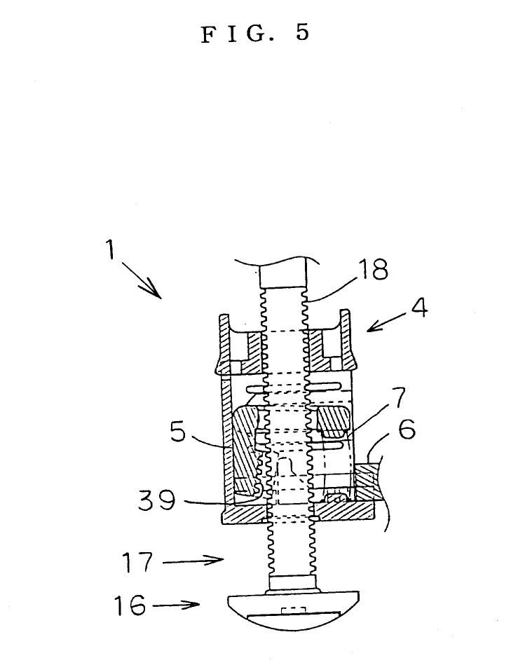

FIG. 1 is an exploded perspective view of the equipment adjusting leg. FIG. 2 is a front view of the equipment adjusting leg in an assembled state. FIG. 3 is a sectional view of the leg. FIGS. 4 are 5 are sectional views of the equipment adjusting leg in the assembled state, and FIG. 4 illustrates the locked state and FIG. 5 illustrates the lock-released state.

An equipment adjusting leg 1 comprises: an attaching case 4 inserted into and mounted on an attaching hole 3 made in the bottom of equipment 2; a locking piece pivoted on the attaching case 4 and placed in the attaching case 4 in a rotatable manner; a push button 6 provided within the attaching case 4 in such a manner that it projects out of the attaching case 4 from an opening 11 of the attaching case 4 and it is capable of sliding; a compression spring 7 fitting in a space between a spring seat 8 on the attaching case 4 and a spring seat 9 on the locking piece 5 so that it presses the locking piece 5 in such a direction as to engage with a concavo-convex part 18 of a leg 10 as described below; and the leg 10 which is inserted through shaft holes 12 and 13 in the attaching case 4, a shaft hole 14 in the locking piece 5, and a notch 15 in the push button 6, and which is supported in a manner freely movable up and down by the shaft holes 12, 13 and 14, and the notch 15 respectively; wherein the shaft holes 12, 13 and 14, and the notch 15 are located concentrically to each other.

Concerning the leg 10, a ground contact part 16 with a larger diameter is formed in its lower part and a sliding shaft 17 is formed in its upper part. Around the periphery of the sliding shaft 17 is formed a screw-like spiral concavo-convex part 18, which is formed in a trapezoidal shape (see FIGS. 3 to 7). The spiral shape of the concavo-convex part 18 enables a fine adjustment by operating the locking piece 5 as described later to adjust the height and then by turning the leg 10 as necessary. When this fine adjustment is made, since the concavo-convex part 18 is in a trapezoidal shape, the engagement of the concavo-convex part 18 of the screw of the leg 10 with a concavo-convex part 39 of the locking piece 5 is barely loosened. Moreover, by adjusting the thickness of the base of the thread (or concavo-convex part 18) to form an obtuse lead angle of the screw (or concavo-convex part 18), the engagement of the concavo-convex part 18 with the concavo-convex part 39 is further tightened and is barely loosened. Furthermore, since the concavo-convex part 18 is in a trapezoidal shape and the angle of inclination of the concavo-convex part 18 is close to 90°, the load capacity is increased and the strength is enhanced by increasing the thickness of the thread.

On the top of the sliding shaft 17 is formed a groove 20 for attaching an E-ring 19 as a stopper.

This leg 10 is composed of: a leg body 22 consisting of the sliding shaft 17 molded with a resin, and a top 21 of the ground contact part 16; and a pad 25 forming a bottom of the ground contact part 16. In the lengthwise direction of the sliding shaft 17, a metal shaft 24 serving as a core is placed in a through hole 23 (a hole that extends from one end to the other end) which is previously made. The upper part of the through hole 23 is formed as a step 26 with a smaller diameter. The metal shaft 24 is inserted and pressed into the through hole 23 from underneath the leg body 22 toward the step 26, and the pad 25 is then attached with a pressure sensitive adhesive double coated tape or an adhesive agent to seal the through hole 23, thereby placing the metal shaft 24 as the core in the leg. The metal shaft 24 is indicated as the core in this example. However, without limitation to such example, any elongated metallic member may be used as the core and, for example, an inexpensive ready-made metal screw may be used.

As the above-mentioned resin, it is desirable to use engineering plastics with excellent mechanical strength, such as polycarbonate, polyamide, polyacetal, PBT, and combinations of these respective materials and glass fibers.

Since the leg body 22 and the pad 25 are formed with the resin, it is possible to obtain, in a short period of time and at low cost, the molded products which are colored to match the color of the equipment by mixing dry colors without the necessity of painting.

By placing the inexpensive metal shaft 24 or the ready-made metal screw as the core in the inexpensive leg body 22, the leg can be manufactured at low cost and without exerting a great amount of effort. Since the peripheral part of the sliding shaft 17 is constructed with the resin which has excellent mechanical strength, and the core is made of metal, it is possible to maintain the impact-resistant strength, to produce the leg 10 in large quantities as described above, and to achieve cost and weight reduction. Since the concavo-convex part 18 of the screw is made of resin, it is possible to design it in accordance with a relevant specification by adjusting a mold to, for example, form the upper part of the screw top in an almost flat shape so that it can withstand a larger load.

The upper part of the sliding shaft 17 is a non-concavo-convex part 27 so that when the leg 10 is turned beyond the movable range, it is caused to slip in order to prevent any damage or breakage.

The attaching case 4 comprises a box part 28 in its lengthwise direction (a vertical direction), the periphery of which fits in the attaching hole 3 in the equipment 2. The attaching case 4 also has a box-shaped case body 29 under the box part 28, and the case body 29 is larger than the box part 28 and has an opening 11 on one of its sides. When the opening 11 side is considered the front side of the case body 29 and the side opposite the opening 11 is considered the rear side of the case body 29, a pair of shaft bearing holes 30 for bearing rotation shafts 31 of the locking piece 5 are formed in both side faces 33 and 34 at upper positions closer to the rear side. Moreover, first guide grooves 32 for guiding the push button 6 to be described later are made in the inside surfaces at the lower positions of the case body 29. Engaging holes 37 to engage with engaging projections 36 of elastic engaging pieces 35 provided on the push button 6 are made in both the side faces 33 and 34 of the case body 29 at lower positions closer to the front side.

At a position closer to the front side on the inside bottom of the attaching case 4, a spring seat 8 for attaching the compression spring 7 is provided in a manner projecting upward.

The locking piece 5 is shaped substantially in the letter “L.” In the lower part of the letter “L” (the lower part of the locking piece 5) is provided an engaging part 38 with a concavo-convex part 39 having a plurality of steps in the midsection of a half cylinder. At the center corner of the letter “L” (on the rear side in the upper part) are provided a pair of rotation shafts on both side faces. In the upper part of the letter “L” (the upper part of the locking piece 5) is provided a top board 40 having a shaft hole 14. At the front edge of the top board 40, a spring seat 9 is provided in a manner projecting downward.

At the rear end of each rotation shaft 31 (the end side of the locking piece 5 to be inserted into the attaching case 4) is provided a slope 49. The attaching case 4 has second guide grooves 50 for guiding the respective rotation shafts 31 to the shaft bearing holes 30. The attaching case 4 also has a plurality of narrow slits 51 so that the case body 29 can easily be flexed. Accordingly, the locking piece 5 can easily be placed in the attaching case 4.

The push button 6 has a sliding part 42 which is located on the side opposite to a pressing part 41 and which has a notch 15 for inserting the sliding shaft 17 of the leg at its shaft center. The sliding part 42 has, on its both side faces in its lengthwise direction, guide projections 43 to fit in the first guide grooves 32 in the attaching case 4. This sliding part 42 also has a pair of elastic engaging pieces 35 with engaging projections 36 to engage with the aforementioned engaging holes 37 in the attaching case 4. (A pair of) rear ends 45 of the sliding part 42 (the end side of the push button 6 to be inserted into the attaching case 4) are formed to come in contact with the lower front ends 46 of the engaging parts 38 of the locking piece 5 and are designed to allow the locking piece 5 to turn by pressing the push button 6. The notch 15 has a second notch 48 in order to avoid contact with the compression spring 7.

An explanation is hereinafter given about how to use the equipment adjusting leg as indicated in Example 1 of this invention.

In order to attach the equipment adjusting leg 1 of this invention to a piece of equipment, the locking piece 5 is first pressed into and placed in the attaching case 4 by aligning the respective rotation shafts 31 to the positions of the respective second guide grooves 50 so that the rotation shafts 31 fit in the shaft bearing holes 30 in the attaching case 4. The compression spring 7 is then placed between the spring seat 9 on the locking piece 5 and the spring seat 8 on the attaching case 4. Subsequently, the press button 6 is placed in the attaching case 4 by causing the guide projections 43 of the sliding part 42 to slide along the respective first guide grooves 32 toward the rear side of the attaching case 4 and by causing the engaging projections 36 of the elastic engaging pieces 35 to engage with the engaging holes 37 in the case body 29.

Then, the sliding shaft 17 of the leg 10, which has the metal shaft 24 previously inserted therein as the core, is inserted in a manner freely movable up and down through the shaft holes 12 and 13 in the attaching case 4, the shaft hole 14 in the locking piece, and the notch 15 in the push button 6 respectively, and these shaft holes 12, 13 and 14, and the notch 15 are located concentrically to each other. The E-ring 9 as a stopper is then attached to the groove 20 in the top end of the leg 10. Subsequently, the box part 28 of the attaching case 4 is pushed into the attaching hole 3 in the equipment 2 from underneath to cause a snap fit 46 provided on the box part 28 to engage with a recess 47 of the attaching hole 3, so that the push button 6 and the leg 10 which has been fixed temporarily are fixed onto the equipment, thereby completing the attachment of the equipment adjusting leg 1. However, without limitation to the above-described snap fit method, any element for attaching the adjusting leg to the equipment may be selected as appropriate, such as fastening with a screw.

At this moment, as shown in FIG. 4, the locking piece 5 turns by means of the repulsion of the compression spring 7 in such a direction as to cause the concavo-convex part 39 of the engaging part 38 to engage with the concavo-convex part 18 of the sliding shaft 17, so that the concavo-convex parts 39 and 18 are brought into engagement and are thereby in a locked state. In this locked state, since the center of the rotation shaft (rotation supporting point) 31 of the locking piece 5 is displaced from the center of the sliding shaft 17, a force is imposed in such a direction as to cause the concavo-convex part 39 to engage with the concavo-convex part 18 of the leg 10. Accordingly, such an advantageous effect can be achieved that prevents the locking piece from turning when a vertical force is applied to the leg from underneath.

In order to adjust the height of the equipment adjusting leg 1, by pressing the pushing part 41 with a hand (or a finger), the rear ends 45 of the push button 6 push the lower front ends 46 of the locking piece, thereby causing the locking piece 5 to turn against the repulsion of the compression spring 7, releasing the engagement of the concavo-convex part 39 with the concavo-convex part 18, and releasing the lock as shown in FIG. 5.

After the height is adjusted, and when the hand (or finger) stops pushing the push button 6, the locking piece 5 turns by means of the repulsion of the compression spring 7 and the concavo-convex part 39 of the engaging part 38 and the concavo-convex part 18 of the leg 10 are brought back into engagement (the engagement is restored), thereby securing the lock again as shown in FIG. 4. If some fine adjustment is further required, the leg 10 is turned to perform the adjustment. When this fine adjustment is made, since the concavo-convex part 18 is in a trapezoidal shape as described above, the engagement of the concavo-convex part 18 of the screw of the leg 10 with the concavo-convex part 39 of the locking piece 5 will never be loosened.

In order to change the height of the adjusting leg 1, for example, when the location of the equipment is changed, actions similar to the above-described actions may be taken by pressing the push button 6 to release the lock, and adjusting the height again, and then the hand (or finger) stops pressing the push button 6 to cause the push button 6 to return to its original position, thereby locking the adjusting leg 1.

### EXAMPLE 2

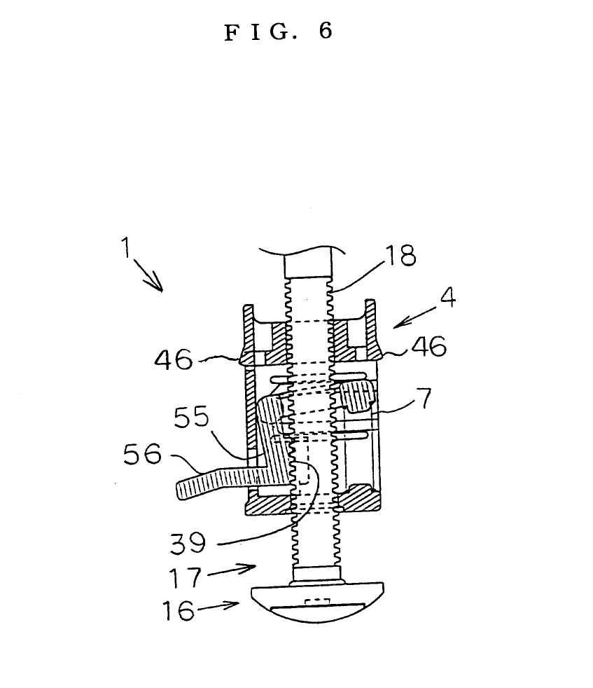

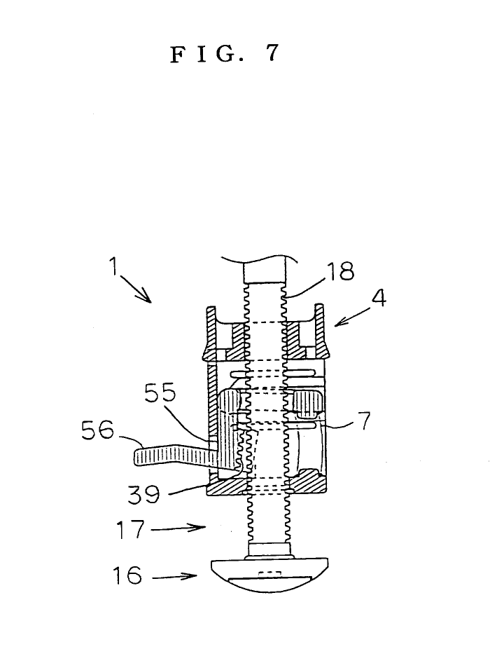

Example 1 describes a combination of the push button 6 and the locking piece 5 that turns by means of back-and-forth sliding movements of the pushbutton 6, but a lever 56 may be used instead of the push button 6. Such example is shown in FIGS. 6 and 7. FIG. 6 is a front view of the adjusting leg in the locked state and FIG. 7 is a front view of the adjusting leg in the lock-released state.

The equipment adjusting leg of Example 2 is provided with, instead of the push button 6, a lever 56 that moves up and down as it turns. Moreover, the lever 56 is formed integrally with a locking piece 55 having a similar structure to that of the locking piece 5. The locking element and other parts of structure are similar to those in Example 1. In order to adjust the height of the equipment adjusting leg from the locked state as shown in FIG. 6, turning the lever 56 upward against the repulsion of the compression spring 7 causes the locking piece 55 formed integrally with the lever to turn, thereby releasing the engagement of the concavo-convex part 18 of the leg sliding shaft 17 with the engaging part 39 of the locking piece 55, releasing the lock as shown in FIG. 7, and enabling the height adjustment.

In the above-described examples, when the metal shaft 24 is attached to the leg body 22, the through hole 23 with the step 26 is made in the leg body 22 and the metal shaft 24 is inserted into the through hole 23 from under the leg body 22, and the pad 25 is placed in such a way to cover the through hole 23 in order to prevent the metal shaft 24 from falling off. However, without limitation to such structure, any structure may be employed as long as the metal shaft 24 will not fall off. For example, the metal shaft 24 may be pressed and fixed in the through hole or be fixed with an adhesive, or the through hole may be provided with an undercut to prevent the metal shaft from falling off. When covering with the pad 25 is unnecessary as described above, the top 21 of the ground contact part 16 can be molded integrally with the pad 25.

In the above-described examples, the concavo-convex part 18 of the screw is made of resin, but it may be made of metal. By using metal and forming the concavo-convex part 18 of the screw into a trapezoidal shape, it is possible to increase load-bearing strength and impact-resistant strength and, therefore, the use of metal is effective when mechanical strength is required. Particularly, it is effective when the diameter of the leg is small.

In the above-described examples, theE-ring 19 mounted on the top of the sliding shaft 17 is used as the stopper element for the sliding shaft 17. However, without limitation to such type of stopper element, a pin may be inserted, instead of the E-ring 19, into the top of the sliding shaft 17, or combinations of the E-ring 19, a screw, and/or a washer may be used, or a snap fit may be provided at the top of the sliding shaft 17.

As the present invention has the above-described structures, the following advantageous effects can be achieved.

Since the concavo-convex part of the adjusting leg of this invention is in a trapezoidal shape, it is possible to provide the equipment adjusting leg concerning which the engagement of the concavo-convex part of the screw of the leg with the locking element is barely loosened when a fine adjustment is made. Moreover, since the concavo-convex part 18 is in a trapezoidal shape and the angle of inclination of the concavo-convex part 18 is close to 90°, it is possible to increase the load capacity and to enhance the strength by increasing the thickness of the thread.

If the concavo-convex part is made of resin, it is possible to design it in accordance with a relevant specification to, for example, form the upper part of the thread top in an almost flat shape in order to withstand a greater load, by adjusting the mold.

What is claimed is:

1. An equipment adjusting leg comprising:
a leg provided in a manner capable of moving back and forth relative to an external frame of a piece of equipment and having a sliding shaft for enabling the movement;
a locking element for locking the back-and-forth movement of the leg; and
a lock release element for releasing the lock;
wherein the sliding shaft has a spiral concavo-convex part formed around its periphery, and the concavo-convex part is in a trapezoidal shape.

2. The equipment adjusting leg according to claim 1, wherein the leg is provided in the lower part of the external frame of the equipment in a manner capable of moving up and down, and the lower part of the leg is formed as a ground contact part and the upper part of the leg is formed as the sliding shaft.

3. The equipment adjusting leg according to claim 1, wherein the sliding shaft is composed of a screw.

4. The equipment adjusting leg according to claim 1, wherein the locking element comprises:
an attaching case for inserting the sliding shaft therethrough;
a locking piece pivoted on the attaching case in a rotatable manner and having a concavo-convex part to engage with the concavo-convex part of the sliding shaft; and
an engagement maintaining element for maintaining the engagement of the concavo-convex part of the sliding shaft with the concavo-convex part of the locking piece;
wherein the concavo-convex part of the sliding shaft is made of resin.

5. The equipment adjusting leg according to claim 4, wherein the resin is made of engineering plastic.

6. The equipment adjusting leg according to claim 5, wherein the engineering plastic is selected from a group consisting of polycarbonate, polyamide, polyacetal, PBT, and combinations of these respective materials and glass fibers.
